(19) United States
(12) Patent Application Publication
(10) Pub. No.: US 2010/0157406 A1
(43) Pub. Date: Jun. 24, 2010

(54) SYSTEM AND METHOD FOR MATCHING LIGHT SOURCE EMISSION TO DISPLAY ELEMENT REFLECTIVITY

(75) Inventors: Russell Wayne Gruhlke, Milpitas, CA (US); Ion Bita, San Jose, CA (US); Kollengode S. Narayanan, Cupertino, CA (US); Lai Wang, Milpitas, CA (US); John Joseph Hannan, San Diego, CA (US); Gang Xu, Cupertino, CA (US); Chong Lee, San Diego, CA (US)

Correspondence Address: KNOBBE, MARTENS, OLSON & BEAR, LLP, 2040 MAIN STREET, FOURTEENTH FLOOR, IRVINE, CA, 92614, US

(73) Assignee: QUALCOMM MEMS Technologies, Inc., San Diego, CA (US)

(21) Appl. No.: 12/340,497

(22) Filed: Dec. 19, 2008

(51) Int. Cl. G02F 1/21

(52) U.S. Cl. 359/238; 977/774; 977/950

(57) ABSTRACT

Systems and methods for illuminating interferometric modulator reflective displays are disclosed. One embodiment includes a display including a plurality of interferometric modulators configured to reflect a spectrum of radiation having a reflectance response peak at one or more wavelengths. A plurality of quantum dots are configured to emit radiation having a peak wavelength substantially at said one or more wavelengths, and the display is configured such that light emitted from the quantum dots irradiates the plurality of interferometric modulators.

### BACKGROUND

1. Field

The field of the invention relates to microelectromechanical systems (MEMS).

2. Description of the Related Technology

Microelectromechanical systems (MEMS) include micro mechanical elements, actuators, and electronics. Micromechanical elements may be created using deposition, etching, and or other micromachining processes that etch away parts of substrates and/or deposited material layers or that add layers to form electrical and electromechanical devices. One type of MEMS device is called an interferometric modulator. As used herein, the term interferometric modulator or interferometric light modulator refers to a device that selectively absorbs and/or reflects light using the principles of optical interference. In certain embodiments, an interferometric modulator may comprise a pair of conductive plates, one or both of which may be transparent and/or reflective in whole or part and capable of relative motion upon application of an appropriate electrical signal. In a particular embodiment, one plate may comprise a stationary layer deposited on a substrate and the other plate may comprise a metallic membrane separated from the stationary layer by an air gap. As described herein in more detail, the position of one plate in relation to another can change the optical interference of light incident on the interferometric modulator. Such devices have a wide range of applications, and it would be beneficial in the art to utilize and/or modify the characteristics of these types of devices so that their features can be exploited in improving existing products and creating new products that have not yet been developed.

### SUMMARY

The system, method, and devices of the invention each have several aspects, no single one of which is solely responsible for its desirable attributes. Without limiting the scope of this invention, its more prominent features will now be discussed briefly. After considering this discussion, and particularly after reading the section entitled “Detailed Description of Certain Embodiments” one will understand how the features of this invention provide advantages over other display devices.

One aspect of the development is a display comprising a plurality of interferometric modulators configured to reflect a spectrum of radiation having a reflectance response peak at one or more wavelengths, and a plurality of quantum dots configured to emit radiation having a peak wavelength substantially at said one or more wavelengths, wherein the display is configured such that light emitted from said quantum dots irradiates said plurality of interferometric modulators.

Another aspect of the development is a method of illumination, comprising illuminating quantum dots with radiation, emitting radiation from said quantum dots, propagating said emitted radiation to interferometric modulators, and reflecting radiation received from said quantum dots from said interferometric modulators, wherein the radiation emitted from said quantum dots has a peak wavelength substantially at said first wavelength, and said first interferometric modulators are configured to reflect a first spectrum of radiation having a reflectance response peak substantially at said first wavelength.

Another aspect of the development is a display comprising means to interferometrically modulate light configured to reflect a first spectrum of radiation having a reflectance response peak at a first wavelength, and means to emit radiation having a peak wavelength substantially at said first wavelength, the display being configured such that said radiation emitting means irradiate said light modulating means.

### BRIEF DESCRIPTION OF THE DRAWINGS

FIG. 1 is an isometric view depicting a portion of one embodiment of an interferometric modulator display in which a movable reflective layer of a first interferometric modulator is in a relaxed position and a movable reflective layer of a second interferometric modulator is in an actuated position.

FIG. 2 is a system block diagram illustrating one embodiment of an electronic device incorporating a 3×3 interferometric modulator display.

FIG. 3 is a diagram of movable mirror position versus applied voltage for one exemplary embodiment of an interferometric modulator of FIG. 1.

FIG. 4 is an illustration of a set of row and column voltages that may be used to drive an interferometric modulator display.

FIGS. 5A and 5B illustrate one exemplary timing diagram for row and column signals that may be used to write a frame of display data to the 3×3 interferometric modulator display of FIG. 2.

FIGS. 6A and 6B are system block diagrams illustrating an embodiment of a visual display device comprising a plurality of interferometric modulators.

FIG. 7A is a cross section of the device of FIG. 1.

FIG. 7B is a cross section of an alternative embodiment of an interferometric modulator.

FIG. 7C is a cross section of another alternative embodiment of an interferometric modulator.

FIG. 7D is a cross section of yet another alternative embodiment of an interferometric modulator.

FIG. 7E is a cross section of an additional alternative embodiment of an interferometric modulator.

FIG. 8A is an exemplary plot of reflectivity versus wavelength.

FIG. 8B is an exemplary plot of intensity of emitted light versus wavelength for an exemplary white light LED.

FIG. 8C is an exemplary plot of intensity of emitted light versus wavelength for a quantum dot film according to one embodiment of the invention.

FIGS. 9A-9D are plan views of a specular display illuminated by a light source incorporating quantum dots.

FIG. 10 is an illustration of a display according to one embodiment of the invention.

FIG. 11 is an illustration of a display according to other embodiments of the invention.

FIGS. 12A-12C are cross sections of displays incorporating quantum dots.

FIGS. 13A-13F illustrate a process of manufacturing quantum dots in an optical component where the quantum dots are formed in a substrate.

FIGS. 14A-14G illustrate another process of manufacturing quantum dots where the quantum dots are formed on a substrate.

FIGS. 15A-15D illustrate a process of manufacturing quantum dots where material comprising the quantum dots is provided into a cavity.

FIG. 16 is a flowchart illustrating a method of displaying an image.

### DETAILED DESCRIPTION OF THE CERTAIN EMBODIMENTS

The following detailed description is directed to certain specific embodiments of the invention. However, the invention can be embodied in a multitude of different ways. In this description, reference is made to the drawings wherein like parts are designated with like numerals throughout. As will be apparent from the following description, the embodiments may be implemented in any device that is configured to display an image, whether in motion (e.g., video) or stationary (e.g., still image), and whether textual or pictorial. More particularly, it is contemplated that the embodiments may be implemented in or associated with a variety of electronic devices such as, but not limited to, mobile telephones, wireless devices, personal data assistants (PDAs), hand-held or portable computers, GPS receivers/navigators, cameras, MP3 players, camcorders, game consoles, wrist watches, clocks, calculators, television monitors, flat panel displays, computer monitors, auto displays (e.g., odometer display, etc.), cockpit controls and/or displays, display of camera views (e.g., display of a rear view camera in a vehicle), electronic photographs, electronic billboards or signs, projectors, architectural structures, packaging, and aesthetic structures (e.g., display of images on a piece of jewelry). MEMS devices of similar structure to those described herein can also be used in non-display applications such as in electronic switching devices.

In general, specular displays modulate the reflectivity of the elements within the display in order to show different images, and under most conditions a specular display modulates and reflects ambient light. In dim or dark conditions, the ambient light is minimal or absent, respectively.

In some devices, a light source has been added to the display. In dark conditions, the light source can be turned on to provide artificial illumination for the display. Under dim conditions, the light source can be turned on to provide additional illumination. By matching the emission spectrum of the light source to the reflectivity spectrum of the display elements, overall efficiency may be increased. This may be accomplished through appropriate selection or design of the light source or of the display elements.

One method of tailoring the spectrum of a light source to match the spectrum of display elements is to use one or more quantum dots to illuminate the display elements. A quantum dot is a small group of atoms that form an individual particle with particular electrical and optical properties. When “pumped,” either electrically or via absorption of radiation, they emit a narrow band of wavelengths. Quantum dots of different sizes, even those made of the same material, can emit different bands of wavelengths, e.g., light of different colors. The emission spectra of organic light emitting material or phosphors are also easily engineered. The emission spectra of light emitting diodes (LEDs) are less easily engineered, but careful selection of LED semiconductor material and/or size can influence the emission spectrum to produce desired wavelengths of light. Quantum dots, organic light emitting material, phosphors, LEDs, and other light sources may be used in various embodiments of the invention.

In one embodiment of tailoring the spectrum of the display elements to match the emission spectrum of a light source, interferometric modulators are used as the display elements. The optical characteristics of an interferometric modulator can be engineered to reflect a certain spectrum of wavelengths based on, among other things, the distance between two layers of the interferometric modulator while in a reflective state. Alternative embodiments include liquid crystal display (LCD) elements and other specular displays. LCD's are generally colored by the use of filters (pigment filters, dye filters, metal oxide filters, etc.). By selecting the properties of the filter, the reflectivity spectrum of the display element can be changed. Other specular displays include an electrophoretic display, which may be colored through the use of filters or pigment particle selection. Interferometric modulators, LCD elements, and electrophoretic display elements, and other specular display elements may be used in various embodiments of the invention.

### Interferometric Modulator Displays

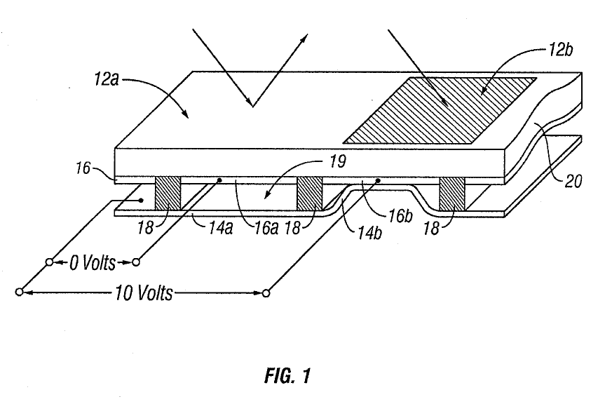

One interferometric modulator display embodiment comprising an interferometric MEMS display element is illustrated in FIG. 1. In these devices, the pixels are in either a bright or dark state. In the bright (“on” or “open”) state, the display element reflects a large portion of incident visible light to a user. When in the dark (“off” or “closed”) state, the display element reflects little incident visible light to the user. Depending on the embodiment, the light reflectance properties of the “on” and “off” states may be reversed. MEMS pixels can be configured to reflect predominantly at selected colors, allowing for a color display in addition to black and white.

FIG. 1 is an isometric view depicting two adjacent pixels in a series of pixels of a visual display, wherein each pixel comprises a MEMS interferometric modulator. In some embodiments, an interferometric modulator display comprises a row/column array of these interferometric modulators. Each interferometric modulator includes a pair of reflective layers positioned at a variable and controllable distance from each other to form a resonant optical cavity with at least one variable dimension. In one embodiment, one of the reflective layers may be moved between two positions. In the first position, referred to herein as the relaxed position, the movable reflective layer is positioned at a relatively large distance from a fixed partially reflective layer. In the second position, referred to herein as the actuated position, the movable reflective layer is positioned more closely adjacent to the partially reflective layer. Incident light that reflects from the two layers interferes constructively or destructively depending on the position of the movable reflective layer, producing either an overall reflective or non-reflective state for each pixel.

The depicted portion of the pixel array in FIG. 1 includes two adjacent interferometric modulators 12a and 12b. In the interferometric modulator 12a on the left, a movable reflective layer 14a is illustrated in a relaxed position at a predetermined distance from an optical stack 16a, which includes a partially reflective layer. In the interferometric modulator 12b on the right, the movable reflective layer 14b is illustrated in an actuated position adjacent to the optical stack 16b.

The optical stacks 16a and 16b (collectively referred to as optical stack 16), as referenced herein, typically comprise of several fused layers, which can include an electrode layer, such as indium tin oxide (ITO), a partially reflective layer, such as chromium, and a transparent dielectric. The optical stack 16 is thus electrically conductive, partially transparent and partially reflective, and may be fabricated, for example, by depositing one or more of the above layers onto a transparent substrate 20. In some embodiments, the layers are patterned into parallel strips, and may form row electrodes in a display device as described further below. The movable reflective layers 14a, 14b may be formed as a series of parallel strips of a deposited metal layer or layers (orthogonal to the row electrodes of 16a, 16b) deposited on top of posts 18 and an intervening sacrificial material deposited between the posts 18. When the sacrificial material is etched away, the movable reflective layers 14a, 14b are separated from the optical stacks 16a, 16b by a defined gap 19. A highly conductive and reflective material such as aluminum may be used for the reflective layers 14, and these strips may form column electrodes in a display device.

With no applied voltage, the cavity 19 remains between the movable reflective layer 14a and optical stack 16a, with the movable reflective layer 14a in a mechanically relaxed state, as illustrated by the pixel 12a in FIG. 1. However, when a potential difference is applied to a selected row and column, the capacitor formed at the intersection of the row and column electrodes at the corresponding pixel becomes charged, and electrostatic forces pull the electrodes together. If the voltage is high enough, the movable reflective layer 14 is deformed and is forced against the optical stack 16. A dielectric layer (not illustrated in this Figure) within the optical stack 16 may prevent shorting and control the separation distance between layers 14 and 16, as illustrated by pixel 12b on the right in FIG. 1. The behavior is the same regardless of the polarity of the applied potential difference. In this way, row/column actuation that can control the reflective vs. non-reflective pixel states is analogous in many ways to that used in conventional LCD and other display technologies.

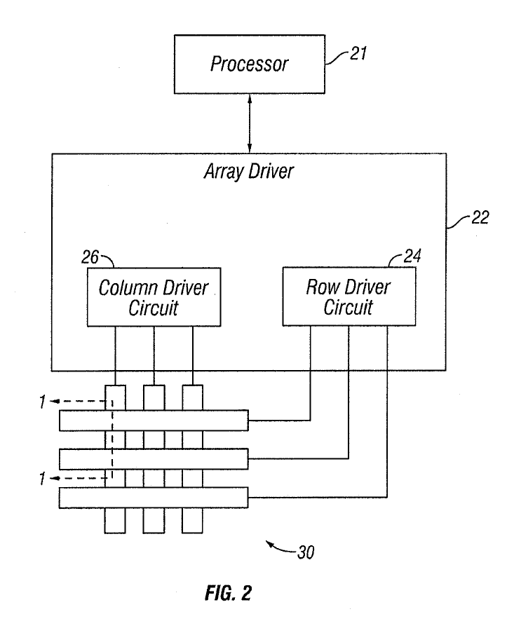

FIGS. 2 through 5 illustrate one exemplary process and system for using an array of interferometric modulators in a display application.

FIG. 2 is a system block diagram illustrating one embodiment of an electronic device that may incorporate aspects of the invention. In the exemplary embodiment, the electronic device includes a processor 21 which may be any general purpose single- or multi-chip microprocessor such as an ARM, Pentium®, Pentium II®, Pentium III®, Pentium IV®, Pentium® Pro, an 8051, a MIPS®, a Power PC®, an ALPHA®, or any special purpose microprocessor such as a digital signal processor, microcontroller, or a programmable gate array. As is conventional in the art, the processor 21 may be configured to execute one or more software modules. In addition to executing an operating system, the processor may be configured to execute one or more software applications, including a web browser, a telephone application, an email program, or any other software application.

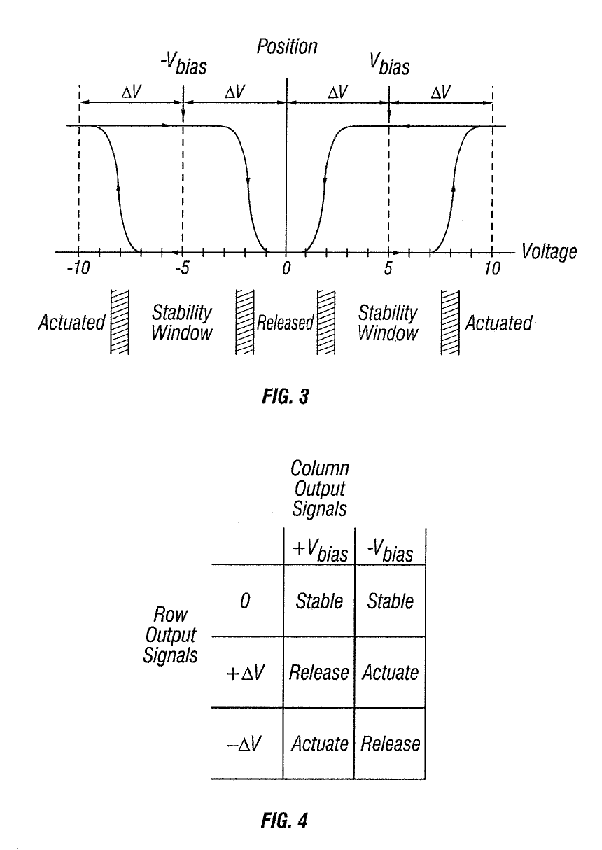

In one embodiment, the processor 21 is also configured to communicate with an array driver 22. In one embodiment, the array driver 22 includes a row driver circuit 24 and a column driver circuit 26 that provide signals to a display array or panel 30. The cross section of the array illustrated in FIG. 1 is shown by the lines 1-1 in FIG. 2. For MEMS interferometric modulators, the row/column actuation protocol may take advantage of a hysteresis property of these devices illustrated in FIG. 3. It may require, for example, a 10 volt potential difference to cause a movable layer to deform from the relaxed state to the actuated state. However, when the voltage is reduced from that value, the movable layer maintains its state as the voltage drops back below 10 volts. In the exemplary embodiment of FIG. 3, the movable layer does not relax completely until the voltage drops below 2 volts. There is thus a range of voltage, about 3 to 7 V in the example illustrated in FIG. 3, where there exists a window of applied voltage within which the device is stable in either the relaxed or actuated state. This is referred to herein as the “hysteresis window” or “stability window.” For a display array having the hysteresis characteristics of FIG. 3, the row/column actuation protocol can be designed such that during row strobing, pixels in the strobed row that are to be actuated are exposed to a voltage difference of about 10 volts, and pixels that are to be relaxed are exposed to a voltage difference of close to zero volts. After the strobe, the pixels are exposed to a steady state voltage difference of about 5 volts such that they remain in whatever state the row strobe put them in. After being written, each pixel sees a potential difference within the “stability window” of 3-7 volts in this example. This feature makes the pixel design illustrated in FIG. 1 stable under the same applied voltage conditions in either an actuated or relaxed pre-existing state. Since each pixel of the interferometric modulator, whether in the actuated or relaxed state, is essentially a capacitor formed by the fixed and moving reflective layers, this stable state can be held at a voltage within the hysteresis window with almost no power dissipation. Essentially no current flows into the pixel if the applied potential is fixed.

In typical applications, a display frame may be created by asserting the set of column electrodes in accordance with the desired set of actuated pixels in the first row. A row pulse is then applied to the row 1 electrode, actuating the pixels corresponding to the asserted column lines. The asserted set of column electrodes is then changed to correspond to the desired set of actuated pixels in the second row. A pulse is then applied to the row 2 electrode, actuating the appropriate pixels in row 2 in accordance with the asserted column electrodes. The row 1 pixels are unaffected by the row 2 pulse, and remain in the state they were set to during the row 1 pulse. This may be repeated for the entire series of rows in a sequential fashion to produce the frame. Generally, the frames are refreshed and/or updated with new display data by continually repeating this process at some desired number of frames per second. A wide variety of protocols for driving row and column electrodes of pixel arrays to produce display frames are also well known and may be used in conjunction with the present invention.

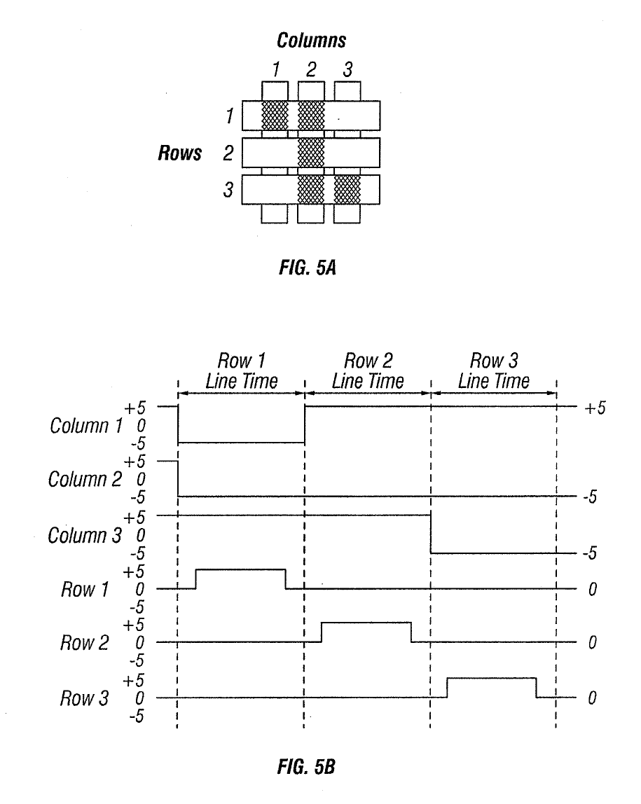

FIGS. 4 and 5 illustrate one possible actuation protocol for creating a display frame on the 3×3 array of FIG. 2. FIG. 4 illustrates a possible set of column and row voltage levels that may be used for pixels exhibiting the hysteresis curves of FIG. 3. In the FIG. 4 embodiment, actuating a pixel involves setting the appropriate column to −V_{bias}, and the appropriate row to +ΔV, which may correspond to −5 volts and +5 volts respectively Relaxing the pixel is accomplished by setting the appropriate column to +V_{bias}, and the appropriate row to the same +ΔV, producing a zero volt potential difference across the pixel. In those rows where the row voltage is held at zero volts, the pixels are stable in whatever state they were originally in, regardless of whether the column is at +V_{bias}, or −V_{bias}. As is also illustrated in FIG. 4, it will be appreciated that voltages of opposite polarity than those described above can be used, e.g., actuating a pixel can involve setting the appropriate column to +V_{bias}, and the appropriate row to −ΔV. In this embodiment, releasing the pixel is accomplished by setting the appropriate column to −V_{bias}, and the appropriate row to the same −ΔV, producing a zero volt potential difference across the pixel.

FIG. 5B is a timing diagram showing a series of row and column signals applied to the 3×3 array of FIG. 2 which will result in the display arrangement illustrated in FIG. 5A, where actuated pixels are non-reflective. Prior to writing the frame illustrated in FIG. 5A, the pixels can be in any state, and in this example, all the rows are at 0 volts, and all the columns are at +5 volts. With these applied voltages, all pixels are stable in their existing actuated or relaxed states.

In the FIG. 5A frame, pixels (1,1), (1,2), (2,2), (3,2) and (3,3) are actuated. To accomplish this, during a “line time” for row 1, columns 1 and 2 are set to −5 volts, and column 3 is set to +5 volts. This does not change the state of any pixels, because all the pixels remain in the 3-7 volt stability window. Row 1 is then strobed with a pulse that goes from 0, up to 5 volts, and back to zero. This actuates the (1,1) and (1,2) pixels and relaxes the (1,3) pixel. No other pixels in the array are affected. To set row 2 as desired, column 2 is set to −5 volts, and columns 1 and 3 are set to +5 volts. The same strobe applied to row 2 will then actuate pixel (2,2) and relax pixels (2,1) and (2,3). Again, no other pixels of the array are affected. Row 3 is similarly set by setting columns 2 and 3 to −5 volts, and column 1 to +5 volts. The row 3 strobe sets the row 3 pixels as shown in FIG. 5A. After writing the frame, the row potentials are zero, and the column potentials can remain at either +5 or −5 volts, and the display is then stable in the arrangement of FIG. 5A. It will be appreciated that the same procedure can be employed for arrays of dozens or hundreds of rows and columns. It will also be appreciated that the timing, sequence, and levels of voltages used to perform row and column actuation can be varied widely within the general principles outlined above, and the above example is exemplary only, and any actuation voltage method can be used with the systems and methods described herein.

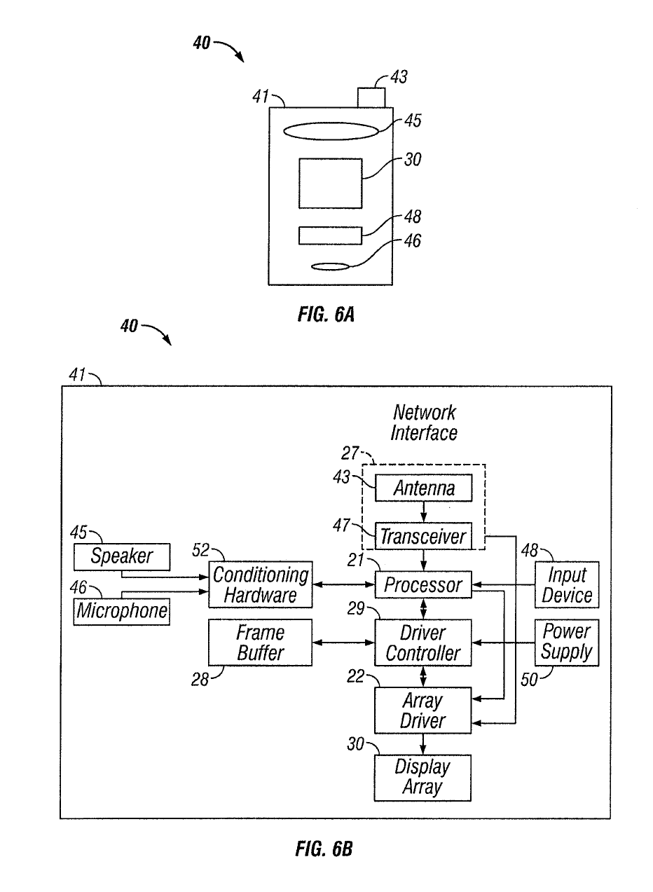

FIGS. 6A and 6B are system block diagrams illustrating an embodiment of a display device 40. The display device 40 can be, for example, a cellular or mobile telephone. However, the same components of display device 40 or slight variations thereof are also illustrative of various types of display devices such as televisions and portable media players.

The display device 40 includes a housing 41, a display 30, an antenna 43, a speaker 44, an input device 48, and a microphone 46. The housing 41 is generally formed from any of a variety of manufacturing processes as are well known to those of skill in the art, including injection molding, and vacuum forming. In addition, the housing 41 may be made from any of a variety of materials, including but not limited to plastic, metal, glass, rubber, and ceramic, or a combination thereof. In one embodiment the housing 41 includes removable portions (not shown) that may be interchanged with other removable portions of different color, or containing different logos, pictures, or symbols.

The display 30 of exemplary display device 40 may be any of a variety of displays, including a bi-stable display, as described herein. In other embodiments, the display 30 includes a flat-panel display, such as plasma, EL, OLED, STN LCD, or TFT LCD as described above, or a non-flat-panel display, such as a CRT or other tube device, as is well known to those of skill in the art. However, for purposes of describing the present embodiment, the display 30 includes an interferometric modulator display, as described herein.

The components of one embodiment of exemplary display device 40 are schematically illustrated in FIG. 6B. The illustrated exemplary display device 40 includes a housing 41 and can include additional components at least partially enclosed therein. For example, in one embodiment, the exemplary display device 40 includes a network interface 27 that includes an antenna 43 which is coupled to a transceiver 47. The transceiver 47 is connected to a processor 21, which is connected to conditioning hardware 52. The conditioning hardware 52 may be configured to condition a signal (e.g. filter a signal). The conditioning hardware 52 is connected to a speaker 45 and a microphone 46. The processor 21 is also connected to an input device 48 and a driver controller 29. The driver controller 29 is coupled to a frame buffer 28, and to an array driver 22, which in turn is coupled to a display array 30. A power supply 50 provides power to all components as required by the particular exemplary display device 40 design.

The network interface 27 includes the antenna 43 and the transceiver 47 so that the exemplary display device 40 can communicate with one ore more devices over a network. In one embodiment the network interface 27 may also have some processing capabilities to relieve requirements of the processor 21. The antenna 43 is any antenna known to those of skill in the art for transmitting and receiving signals. In one embodiment, the antenna transmits and receives RF signals according to the IEEE 802.11 standard, including IEEE 802.11(a), (b), or (g). In another embodiment, the antenna transmits and receives RF signals according to the BLUETOOTH standard. In the case of a cellular telephone, the antenna is designed to receive CDMA, GSM, AMPS or other known signals that are used to communicate within a wireless cell phone network. The transceiver 47 pre-processes the signals received from the antenna 43 so that they may be received by and further manipulated by the processor 21. The transceiver 47 also processes signals received from the processor 21 so that they may be transmitted from the exemplary display device 40 via the antenna 43.

In an alternative embodiment, the transceiver 47 can be replaced by a receiver. In yet another alternative embodiment, network interface 27 can be replaced by an image source, which can store or generate image data to be sent to the processor 21. For example, the image source can be a digital video disc (DVD) or a hard-disc drive that contains image data, or a software module that generates image data.

Processor 21 generally controls the overall operation of the exemplary display device 40. The processor 21 receives data, such as compressed image data from the network interface 27 or an image source, and processes the data into raw image data or into a format that is readily processed into raw image data. The processor 21 then sends the processed data to the driver controller 29 or to frame buffer 28 for storage. Raw data typically refers to the information that identifies the image characteristics at each location within an image. For example, such image characteristics can include color, saturation, and gray-scale level.

In one embodiment, the processor 21 includes a microcontroller, CPU, or logic unit to control operation of the exemplary display device 40. Conditioning hardware 52 generally includes amplifiers and filters for transmitting signals to the speaker 45, and for receiving signals from the microphone 46. Conditioning hardware 52 may be discrete components within the exemplary display device 40, or may be incorporated within the processor 21 or other components.

The driver controller 29 takes the raw image data generated by the processor 21 either directly from the processor 21 or from the frame buffer 28 and reformats the raw image data appropriately for high speed transmission to the array driver 22. Specifically, the driver controller 29 reformats the raw image data into a data flow having a raster-like format, such that it has a time order suitable for scanning across the display array 30. Then the driver controller 29 sends the formatted information to the array driver 22. Although a driver controller 29, such as a LCD controller, is often associated with the system processor 21 as a stand-alone Integrated Circuit (IC), such controllers may be implemented in many ways. They may be embedded in the processor 21 as hardware, embedded in the processor 21 as software, or fully integrated in hardware with the array driver 22.

Typically, the array driver 22 receives the formatted information from the driver controller 29 and reformats the video data into a parallel set of waveforms that are applied many times per second to the hundreds and sometimes thousands of leads coming from the display's x-y matrix of pixels.

In one embodiment, the driver controller 29, array driver 22, and display array 30 are appropriate for any of the types of displays described herein. For example, in one embodiment, driver controller 29 is a conventional display controller or a bi-stable display controller (e.g., an interferometric modulator controller). In another embodiment, array driver 22 is a conventional driver or a bi-stable display driver (e.g., an interferometric modulator display). In one embodiment, a driver controller 29 is integrated with the array driver 22. Such an embodiment is common in highly integrated systems such as cellular phones, watches, and other small area displays. In yet another embodiment, display array 30 is a typical display array or a bi-stable display array (e.g., a display including an array of interferometric modulators).

The input device 48 allows a user to control the operation of the exemplary display device 40. In one embodiment, input device 48 includes a keypad, such as a QWERTY keyboard or a telephone keypad, a button, a switch, a touch-sensitive screen, a pressure- or heat-sensitive membrane. In one embodiment, the microphone 46 is an input device for the exemplary display device 40. When the microphone 46 is used to input data to the device, voice commands may be provided by a user for controlling operations of the exemplary display device 40.

Power supply 50 can include a variety of energy storage devices as are well known in the art. For example, in one embodiment, power supply 50 is a rechargeable battery, such as a nickel-cadmium battery or a lithium ion battery. In another embodiment, power supply 50 is a renewable energy source, a capacitor, or a solar cell, including a plastic solar cell, and solar-cell paint. In another embodiment, power supply 50 is configured to receive power from a wall outlet.

In some implementations control programmability resides, as described above, in a driver controller which can be located in several places in the electronic display system. In some cases control programmability resides in the array driver 22. Those of skill in the art will recognize that the above-described optimization may be implemented in any number of hardware and/or software components and in various configurations.

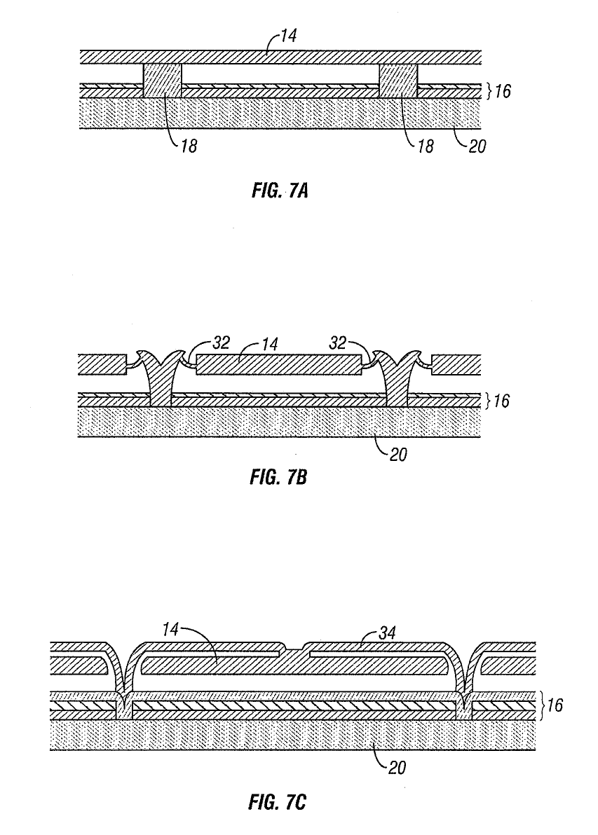

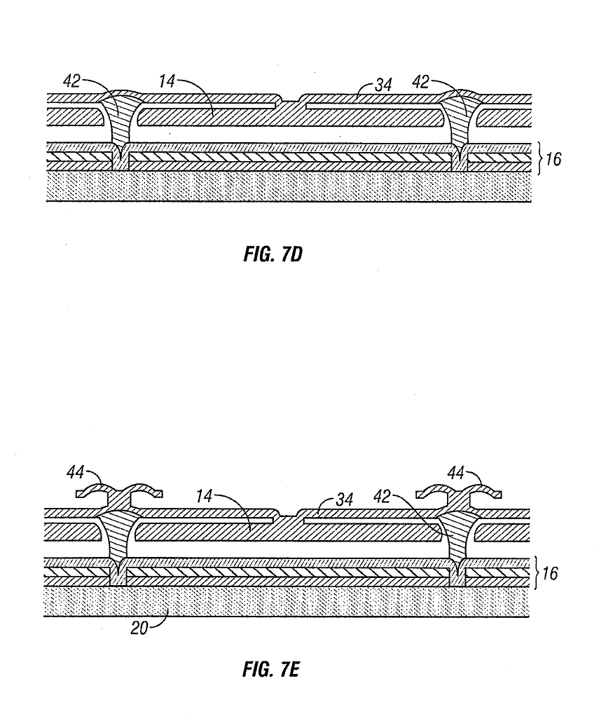

The details of the structure of interferometric modulators that operate in accordance with the principles set forth above may vary widely. For example, FIGS. 7A-7E illustrate five different embodiments of the movable reflective layer 14 and its supporting structures. FIG. 7A is a cross section of the embodiment of FIG. 1, where a strip of metal material 14 is deposited on orthogonally extending supports 18. In FIG. 7B, the moveable reflective layer 14 is attached to supports at the corners only, on tethers 32. In FIG. 7C, the moveable reflective layer 14 is suspended from a deformable layer 34, which may comprise a flexible metal. The deformable layer 34 connects, directly or indirectly, to the substrate 20 around the perimeter of the deformable layer 34. These connections are herein referred to as support posts. The embodiment illustrated in FIG. 7D has support post plugs 42 upon which the deformable layer 34 rests. The movable reflective layer 14 remains suspended over the cavity, as in FIGS. 7A-7C, but the deformable layer 34 does not form the support posts by filling holes between the deformable layer 34 and the optical stack 16. Rather, the support posts are formed of a planarization material, which is used to form support post plugs 42. The embodiment illustrated in FIG. 7E is based on the embodiment shown in FIG. 7D, but may also be adapted to work with any of the embodiments illustrated in FIGS. 7A-7C as well as additional embodiments not shown. In the embodiment shown in FIG. 7E, an extra layer of metal or other conductive material has been used to form a bus structure 44. This allows signal routing along the back of the interferometric modulators, eliminating a number of electrodes that may otherwise have had to be formed on the substrate 20.

In embodiments such as those shown in FIG. 7, the interferometric modulators function as direct-view devices, in which images are viewed from the front side of the transparent substrate 20, the side opposite to that upon which the modulator is arranged. In these embodiments, the reflective layer 14 optically shields the portions of the interferometric modulator on the side of the reflective layer opposite the substrate 20, including the deformable layer 34. This allows the shielded areas to be configured and operated upon without negatively affecting the image quality. Such shielding allows the bus structure 44 in FIG. 7E, which provides the ability to separate the optical properties of the modulator from the electromechanical properties of the modulator, such as addressing and the movements that result from that addressing. This separable modulator architecture allows the structural design and materials used for the electromechanical aspects and the optical aspects of the modulator to be selected and to function independently of each other. Moreover, the embodiments shown in FIGS. 7C-7E have additional benefits deriving from the decoupling of the optical properties of the reflective layer 14 from its mechanical properties, which are carried out by the deformable layer 34. This allows the structural design and materials used for the reflective layer 14 to be optimized with respect to the optical properties, and the structural design and materials used for the deformable layer 34 to be optimized with respect to desired mechanical properties.

As mentioned above, MEMS pixels can be configured to reflect predominantly at selected colors, allowing for a color display in addition to black and white. A color display may, for example, comprise an array of elements wherein each element consists of three sub-elements corresponding to the colors red, green, and blue. Each sub-element may comprise one or more interferometric modulators able to, in a first state, predominantly reflect a particular color and to, in a second state, not reflect light.

Interferometric modulators may also be designed with more than two states. In one embodiment, an interferometric modulator has four states, one corresponding to an “off” state in which light is not reflected, and one state corresponding to each of three colors.

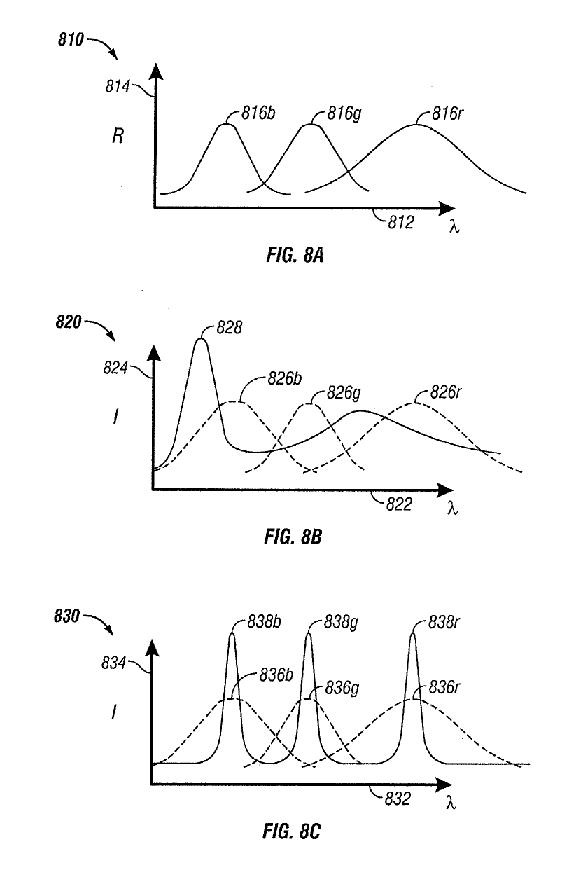

FIG. 8A is an exemplary plot of reflectivity versus wavelength. The plot 810 comprises a wavelength axis 812, a reflectivity axis 814, and three reflectivity profiles 816r, 816g, 818b. In one embodiment, the three reflectivity profiles 816 correspond to three interferometric modulators in a reflective state. In another embodiment, the three reflectivity profiles 816 correspond to three reflective states of a single interferometric modulator.

In one embodiment, the three profiles 816 correspond to visible light generally perceived as red light, green light, and blue light. In one embodiment, the red reflectivity profile 816r has a peak reflectivity at about 650 nm, the green reflectivity profile 816g has a peak reflectivity at about 510 nm and the blue reflectivity profile has a peak reflectivity at about 475 nm. The structural differences (e.g., dimensions) can cause interferometric modulators to exhibit reflectivity profiles 816 of different spectrum widths and/or relative peak reflectivity. In other embodiments, interferometric modulators can be configured such that a peak of the reflectivity profiles 816 correspond to the one or more regions of wavelengths, or peaks, of the responsivity spectra of human cone cells, for example, generally between about 420-440 nm, about 535-545 nm, and about 565-680 nm.

In poorly lit conditions, including dark and dim conditions, specular displays, which modulate and reflect light, may not be easily viewed. To mitigate this problem, displays can include a light source. One such light source is a “white” light emitting diode (LED).

There are various ways of producing high intensity broad spectrum (white) light using LEDs. For example, one embodiment uses individual LEDs that emit three primary colors (e.g., red, green, and blue) and then mix the colors to produce white light. Such LEDs may be referred to as multi-colored white LEDs. Alternatively, they may be referred to as RGB LEDs. Because producing a multi-colored white LED often involves sophisticated electro-optical design to control the blending and diffusion of different colors, this approach has rarely been used to mass produce white LEDs in the industry. However, such an approach may be beneficial when other light modulation is performed, such as in the case of an interferometric modulator display.

There are several types of multi-colored white LEDs: di-, tri-, and tetrachromatic white LEDs. Several key factors that may influence these different approaches include color stability, color rendering capability, and luminous efficacy. Often higher efficacy will mean lower color rendering, presenting a trade off between the luminous efficiency and color rendering. For example, the dichromatic white LEDs have the best luminous efficiency (120 lm/W), but the lowest color rendering capability. Oppositely, although tetrachromatic white LEDs have excellent color rendering capability, they often have poor luminous efficiency. Trichromatic white LEDs are in between, having both good luminous efficiency (>70 lm/W) and fair color rendering capability.

Another embodiment uses a light emitting material to convert the monochromatic light from a short wavelength LED (e.g., a blue or ultraviolet LED) to broad-spectrum light. An LED of one color can be coated with phosphors of different colors to produce white light. The resulting LED may be referred to as a phosphor-based white LED. A fraction of the lower-wavelength light undergoes a Stokes shift being transformed from shorter wavelengths to longer wavelengths. Depending on the color of the original LED, phosphors of different colors can be employed. If several phosphor layers of distinct colors are applied, the emitted spectrum is broadened, effectively increasing the color rendering index (CRI) value of a given LED. However, phosphor-based LEDs may have a lower efficiency then other LEDs due to the heat loss from the Stokes shift and also other phosphor-related degradation issues.

In one embodiment, a phosphor-based white LED comprises an InGaN blue LED inside of a phosphor-coated epoxy. A yellow phosphor material is cerium-doped yttrium aluminum garnet (Ce3+:YAG). In another embodiment, a phosphor-based white LED comprises a near ultraviolet (NUV) emitting LEDs coated with a mixture of high efficiency europium-based red and blue emitting phosphors plus green-emitting copper- and aluminum-doped zinc sulfide (ZnS:Cu,Al). However, the ultraviolet light causes photodegradation to the epoxy resin and many other materials used in LED packaging, causing manufacturing challenges and shorter lifetimes. This method is less efficient than the blue LED with YAG:Ce phosphor, as the Stokes shift is larger and more energy is therefore converted to heat, but yields light with better spectral characteristics, which render color better. Due to the higher radiative output of the ultraviolet LEDs compared to that of the blue ones, both approaches offer comparable brightness.

Another method for producing white LEDs uses no phosphors at all and is based on homoepitaxially grown zinc selenide (ZnSe) on a ZnSe substrate which simultaneously emits blue light from its active region and yellow light from the substrate. The above-described white LEDs may be used as a light source with suitably configured quantum dots that are configured to emit a desired wavelength emission profile to match the reflectivity profile of one or more interferometric modulators.

FIG. 8B is an exemplary plot of the intensity of emitted light versus wavelength for a light source. The plot 820 comprises a wavelength axis 822, an intensity axis 824, and an intensity profile 828. Also shown for reference are reflectivity profiles 826r, 826g, 826b similar to those illustrated in FIG. 8A. In one embodiment, the intensity profile 828 comprises a peak intensity corresponding to short-wavelength light and a broad spectrum of intensities at higher-wavelengths. Such a profile may correspond to a Stokes-shifted light of a phosphor-based white LED. In the embodiment shown in FIG. 8B, the intensity profile 828 is not effectively matched to the reflectivity profiles 826. In other words, one or more of the intensity peaks of the intensity profile 828 and reflectivity peaks of the reflectivity profiles 826 are not substantially aligned with respect to the wavelength axis 822, so that an emission spectrum of the light source is not matched to the reflectivity of the interferometric modulators. Matching the intensity profile of the light source and the reflectivity profile of the interferometric modulators would produce a display which reflects more light. Such a display appears brighter and has a higher efficiency for the same amount of light provided by the light source.

FIG. 8C is an exemplary plot of intensity of emitted light versus wavelength for another light source. The plot 830 comprises a wavelength axis 832, an intensity axis 834, and an intensity profile with three peaks 838r, 838g, 838b. Also shown for reference are reflectivity profiles 836r, 836g, 836b similar to the reflectivity profiles illustrated in FIG. 8A. In the embodiment illustrated in FIG. 8C, the intensity profile 838 exhibits an intensity peak at three different wavelengths, each which substantially matches a peak wavelength in the reflectivity profiles 836. For example, the intensity profiles 838 have a peak wavelength that is within plus or minus 10 nm of a peak wavelength, or center wavelength, of a reflectivity profile. In this way, more of the energy provided by the light source is reflected as visible light so the display appears brighter for a given amount of light provided by the light source. Matching the light source to interferometric modulators can be accomplished by selecting appropriate materials for a multi-colored white LED, or designing the interferometric modulators to match the spectra of existing multi-colored white LEDs.

In other embodiments, a light source may illuminate quantum dots which generate an emission spectrum that matches reflectivity profiles of one or more sets of interferometric modulators. The quantum dots may be configured with light emission properties to produce light having wavelengths that can encompass peak wavelength emission which matches the reflectivity profile of an interferometric modulator. In some embodiments, the emitted light is centered around a desired peak wavelength. In some embodiments, the quantum dots can include two or more differently configured sets of quantum dots, each set selected to emit light that has a particular peak wavelength. For example, in some embodiments the quantum dots include three differently configured sets of quantum dots. Each set of quantum dots can be configured to emit light having a different peak wavelength (e.g., red, green, or blue), each corresponding to a reflectivity profile of a set of interferometric modulators.

Quantum dots are available from several sources. One kind of quantum dot, for example, is sold under the trade name Qdots® and is manufactured and distributed by Quantum Dot Corp. of Palo Alto, Calif. A single quantum dot comprises a small group of atoms that form an individual particle. These quantum dots may comprise various materials including semiconductors such as zinc selenide (ZnSe), cadmium selenide (CdSe), cadmium sulfide (CdS), indium arsenide (InAs), indium phosphide (InP), and titanium dioxide (TiO₂).

The size of the quantum dot may range from about 1 to about 10 nm, or larger. Quantum dots absorb a broad spectrum of optical wavelengths and reemit radiation having a wavelength that is longer than the wavelength of the absorbed light. The wavelength of the emitted light is governed by the size of the quantum dot. CdSe quantum dots that are about 5.0 nm in diameter emit radiation having a narrow spectral distribution centered at about 625 nm. Quantum dots comprising CdSe that are about 2.2 nm in diameter emit light with a peak wavelength of about 500 nm. Semiconductor quantum dots comprising CdSe, InP, and InAs, can emit radiation having peak wavelengths in the range between about 400 nm to about 1.5 μm. And quantum dots comprising titanium dioxide also emit radiation with wavelengths in this same range. The linewidth of radiation emission, e.g., full-width half-maximum (FWHM), for these semiconductor materials may range from about 20 nm to about 30 nm. To produce this narrowband emission, quantum dots absorb wavelengths shorter than the wavelength of the light emitted by the dots. For example, for about 5.0 nm diameter CdSe quantum dots, light having wavelengths shorter than about 625 is absorbed to produce emission at about 625 nm, while for about 2.2 nm quantum dots comprising CdSe, wavelengths smaller than about 500 nm are absorbed and radiation is emitted at about 500 nm. In practice, however, the excitation or pump radiation absorbed by the quantum dot can be at least about 50 nm shorter than the emitted radiation.

Although quantum dots have been described above as devices which absorb and reemit light, quantum dots may also be “pumped,” or excited, electrically, by applying a voltage or current to the quantum dot. The emission spectrum emitted for the quantum dots may be similar regardless of the whether the quantum dots are pumped electrically or optically.

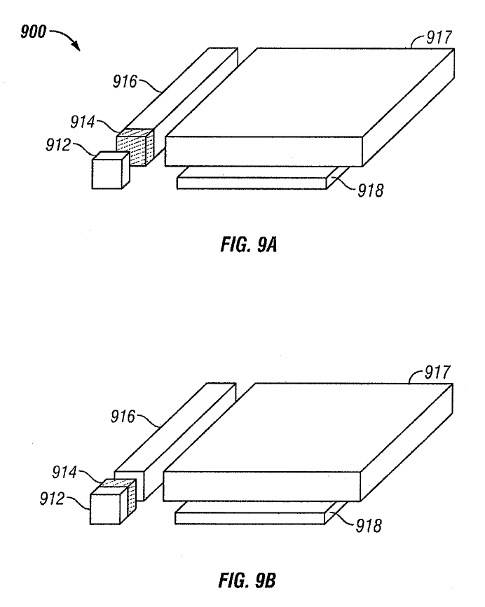

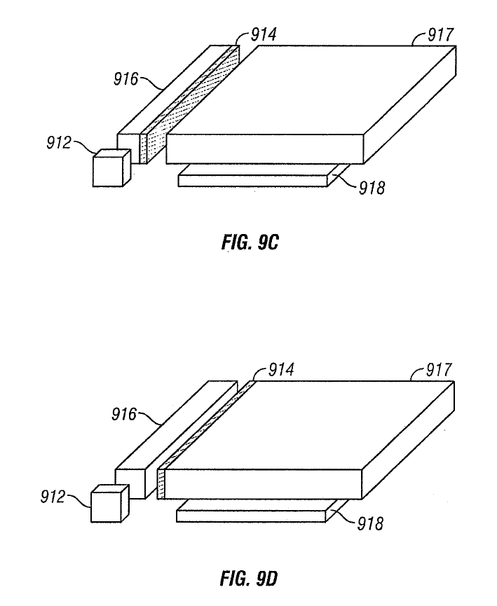

FIGS. 9A-9D illustrate embodiments of light guides that can be used in various displays, including reflective interferometric modulator displays, that comprise quantum dots and a light source. The quantum dots may be configured to receive radiation from the light source and emit light of one spectrum of wavelengths (for example, a single color), or two or more spectrums of wavelengths (for example, three colors). The quantum dots are configured to match the reflectivity profiles of elements of the display. In these embodiments, and other embodiments described herein, the display elements are interferometric modulators. Other embodiments may incorporate other types of reflective display elements to receive and modulate light emitted from the quantum dots. The quantum dots can be disposed on the described surfaces. In some embodiments, the quantum dots are disposed on surfaces and below surfaces of the described optical components. In other embodiments, the quantum dots can be disposed within the optical components.

In one embodiment, shown in FIG. 9A, the display 910 comprises a light source 912, a layer of quantum dots 914, a light bar 916, a light guide 917, and an array of display elements 918. The light source 912 may be any device capable of producing light. The light source 912 may comprise an LED, such as a multi-colored or phosphor-based white LED. The quantum dots 914 are structured to absorb light emitted from the light source and reemit light at one or more different wavelengths which are better matched to the reflective properties of the display elements. The array of display elements 918 may comprise liquid crystal display (LCD) elements, interferometric modulators, or any specular display element. The light bar 916 and the light guide 917 redirect light emitted from the light source 912 to the array of display elements 918. The light guide 917 is positioned over the array of display elements 918 such that light from the light source 912 and incident light passes through the light guide 917 while propagating to the array of display elements 918. The display is configured such that light emitted from the light source 912 is redirected by the light bar 916 to the light guide 917, where it is further redirected downwards to the array of display elements 918. In FIG. 9A the light bar 916 is shown disposed near the left edge of the light guide 917. However, the light bar 916 can be placed near any suitable edge of the light guide 917 if the light guide is configured to receive light through that particular film edge and redirect the light to the array of display elements 918.

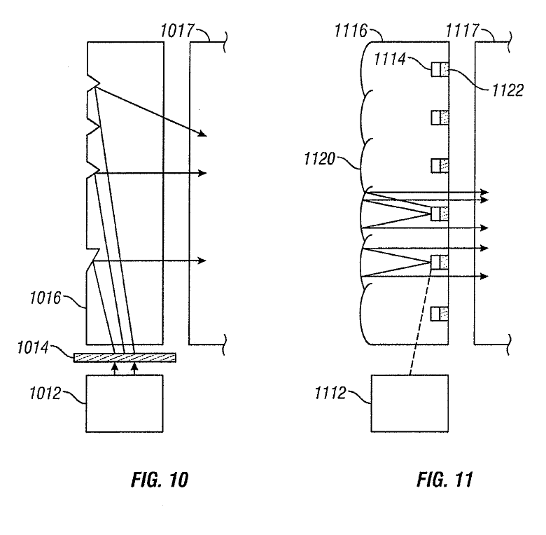

FIG. 9A shows a layer of quantum dots 914 affixed to a light receiving area of the light bar 916 to receive light emitted from the light source. In some embodiments, the quantum dots are disposed on a light receiving surface of the light bar 916. In other embodiments the quantum dots are disposed on or below a light receiving surface of the light bar 916. However, the quantum dots may also be disposed in other locations along the light propagation path between the light source and the array of display elements 918. In one embodiment, shown in FIG. 9B, the quantum dots 914 are affixed to the light source 912, such that radiation emitted by the light source 912 is absorbed by the quantum dots, which then emit light which enters the light bar 916. In another embodiment, shown in FIG. 9C, the quantum dots 914 are affixed to a surface of the light bar 916 between the light bar 916 and the light guide 917. In yet another embodiment, shown in FIG. 9D, the quantum dots 914 are affixed to an edge of the light guide 917 between the light bar 916 and the light guide 917. In still other embodiments, the quantum dots 914 are affixed to the light guide 917 between the light guide 917 and the array of display elements 918 (not shown), or are affixed to the array of display elements 918 between the light guide 917 and the array 918 (not shown). In other embodiments, the quantum dot layer 914 is not affixed to the light source 912, light bar 916, light guide 917, or array 918. Instead, the quantum dots may be disposed in a layer, for example, on a separate structure, as shown in FIG. 10.

FIG. 10 is an illustration of a display according to one embodiment. The illustrated display includes a light source 1012, a layer of quantum dots 1014, a light bar 1016, and a light guide 1017. In operation, the light source 1012 emits light including short-wavelength components. The short-wavelength radiation from the light source 1012 is absorbed by the quantum dots 1014, which emit this energy as light having a longer wavelength than the absorbed radiation. The emitted light may, in some embodiments, have a spectrum as shown in FIG. 8C, which substantially matches the reflectivity spectra of the display elements in an array of display elements which it illuminates. In this embodiment, the light emitted by the quantum dots 1014 propagates through the light bar 1016 towards the light guide 1017. The light guide 1017 receives the light and redirects it towards the array of display elements. Various structures can be included in the light guide 1017 to redirect the light to the array of display elements. In one embodiment, the light bar 1016 is a transparent material, such as glass, which includes protrusions 1020 cut into the light bar 1016 which act as mirrors. The light bar 1016 may be designed such that extraction efficiency varies with distance from the light source 1012, such that the intensity of light exiting a surface of the light bar 1016 is uniform across the surface.

FIG. 11 is an illustration of a display according to another embodiment of the invention. The illustrated display comprises a light source 1112, a light bar 1116, quantum dots 1114, and a light guide 1117. The functionality of the display 1100 is similar to that described with reference to FIG. 10. Light is emitted from the light source 1112, where it is propagated through a portion of the light bar 1116 and absorbed by one or more quantum dots 1114. The light emitted by the quantum dots 1114 is propagated in two directions, towards a number of parabolic mirrors 1120 fashioned in the light bar 1116 (to the left in FIG. 11) and towards the light guide 1117 (to the right in FIG. 11), where the light is further redirected to an array of display elements. Light propagated in the first direction can be reflected and collimated by the parabolic mirrors 1120, and then propagate from the mirrors to the light guide 1117. Light which could propagate from the quantum dots 1114 directly towards the light guide 1117 is not likewise collimated. Some embodiments include one or more reflectors 1122, each reflector 1122 being positioned between a quantum dot 1114 and the light guide 1117. Light emitted by the quantum dot 1114 toward the display is reflected by the reflector 1122 towards a parabolic mirror 1120. The light is collimated by a parabolic mirror and reflected towards the light guide 1117 for subsequent modulation by an array of display elements.

In some embodiments, there are three types of quantum dots 1114 corresponding to the three intensity peaks of the intensity profile of FIG. 8C. In one embodiment, each parabolic mirror reflects and collimates light from a single type of quantum dot, which is located at the focus of the parabolic mirror. In other embodiments, all three quantum dot types are collocated at the focus of each parabolic mirror.

Although the embodiments described above have included a light source to optically pump the quantum dots, in other embodiments the quantum dots are pumped electrically, obviating the light source.

One challenge in front light design is the prevention of artifacts which tend to occur especially in bright lighting conditions. For example, any obstruction to ambient light may advantageously be smaller than the human eye resolution, e.g., less than 50-100 microns in diameter at approximately arm's length. Also, the obstruction may advantageously be smaller than a display element pixel size, which may be as small as 50×50 microns. Quantum dots with an emission spectrum (or spectra) designed to match the reflectivity profiles of display elements may be small enough that they are invisible to the naked eye. Thus, an areal distribution of quantum dots positioned in front of a reflective display may not be noticeable to a user of the display. By electrically exciting a layer of quantum dots on top of display, the display can be used in dark or dim conditions, where light emitted by the quantum dots would be modulated and reflected by the display elements into the eyes of the user.

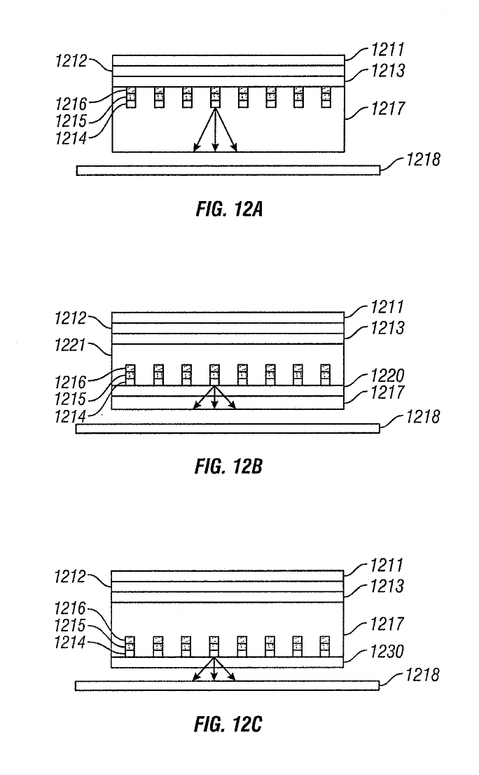

FIGS. 12A-12C are cross sections of displays incorporating quantum dots 1214. FIG. 12A illustrates an embodiment of a display 1200 that comprises a substrate 1217 and one or more thin film layers disposed above an array of reflective display elements 1218. The substrate 1217 is fabricated to include a plurality of quantum dots 1214, which may be configured similarly to emit light of similar wavelengths, or the quantum dots may include two of more differently configured quantum dots which emit light having two or more different sets of wavelengths, respectively. The quantum dots 1214 may be regularly, irregularly, or randomly spaced laterally. In some embodiments, one or more quantum dots are positioned directly above each display element. Furthermore, a quantum dot emitting a particular color of light (e.g., red, green, or blue) may be spaced directly above a display element that is configured with a reflectivity profile advantageous for that particular color. Proper spacing and aligning particularly configured quantum dots with associated display elements may provide additional color purity and resolution.

Still referring to FIG. 12A, this embodiment also includes a reflector 1215 positioned adjacent to each quantum dot 1214 such that the quantum dot 1214 is between the reflector 1215 and the array of display elements 1218. Some embodiments may not include a reflector 1215. In operation, light emitted by a quantum dot 1214 may be emitted in many directions, including away from the array of display elements 1281. Light incident on the reflector 1215 is reflected towards the array of display elements 1218, where it is modulated, rather than propagating un-modulated towards a viewer of the display which would result in decreased contrast. An absorber 1216 may be positioned adjacent to the reflector 1215 on the side opposite of the quantum dot 1214. The absorber 1216 can reduce the reflection of ambient light and further increase display contrast. The display can further include one or more of a light diffusion layer 1213, a protective plastic coating 1212, and an anti-reflective coating 1211 to reduce glare.

An exemplary electrically excited quantum dot geometry comprises two conductive layers and a semiconductor layer. Additional dielectric layers may be present as well. At least one of the conductive layers is transparent in the visible portion of the electromagnetic spectrum. In some embodiments, the reflector 1215 may be one of the conductive layers.

In another embodiment of a display 1205 is illustrated in FIG. 12B. Display 1205 comprises quantum dots 1214 that are not fabricated into the substrate 1217, but instead are positioned on top of a clear layer 1220, surrounded by a dielectric 1221. Display 1205 also may include one or more of a reflector 1216, an absorber 1215, a light diffusion layer 1213, a protective plastic coating 1212, and an anti-reflective coating 1211.

FIG. 12C illustrates another embodiment of a display 1210, where quantum dots 1214 are positioned closed to an array of display elements 1218, by being fabricated in the array-side of the glass substrate 1217. A dielectric buffer 1230 may be fabricated between the substrate 1217 and the array of display elements 1218 for protection. Display 1210 also may include one or more of a reflector 1216, an absorber 1215, a light diffusion layer 1213, a protective plastic coating 1212, and an anti-reflective coating 1211.

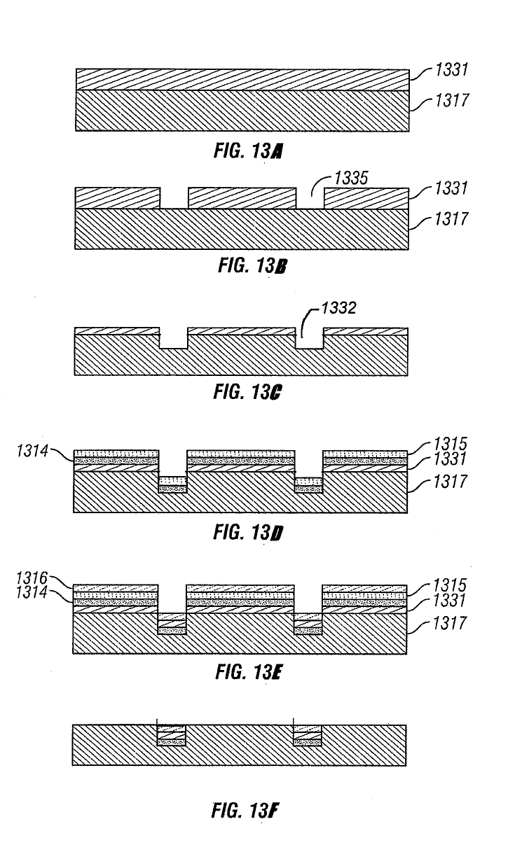

FIGS. 13 through 15 are illustrations of manufacturing processes useful in producing quantum dots for light guides and displays, which can be used, for example, for manufacturing the embodiments illustrated in FIGS. 12A-12C above. The process illustrated by FIGS. 13A-13F, for example, may be useful in fabricating a display according to FIG. 12A. The Figures illustrate various states of a display during the manufacturing process, as the manufacturing progresses from a first state (shown in FIGS. 13A, 14A, and 15A) to a final state (shown in FIGS. 13F, 14G, and 15D).

Referring now to FIG. 13A, the process begins with a substrate 1317 upon which a photo resist layer 1331 is coated. FIG. 13B shows the device after the photo resist layer 1331 has been patterned using, e.g., lithography or any appropriate method to form a number of holes 1335 positioned where quantum dots are desired. FIG. 13C shows the device after an etching process, e.g., wet etching or dry etching, in which holes 1332 in the substrate 1317 are formed and the photo resist layer 1331 is partially removed. As shown in FIG. 13D, a quantum dot layer 1314 is deposited on the display, as well as a reflective cover layer 1315 such that the reflective cover 1315 is formed on the quantum dot 1314. In some embodiments the reflective cover layer 1315 comprises a metal. As shown in FIG. 13E, an absorbing layer 1316 is deposited such that an absorbing layer 1316 is formed on the reflective cover 1315. Finally, as shown in FIG. 13F, photo resist liftoff techniques are used to remove all but the layers in the substrate holes.

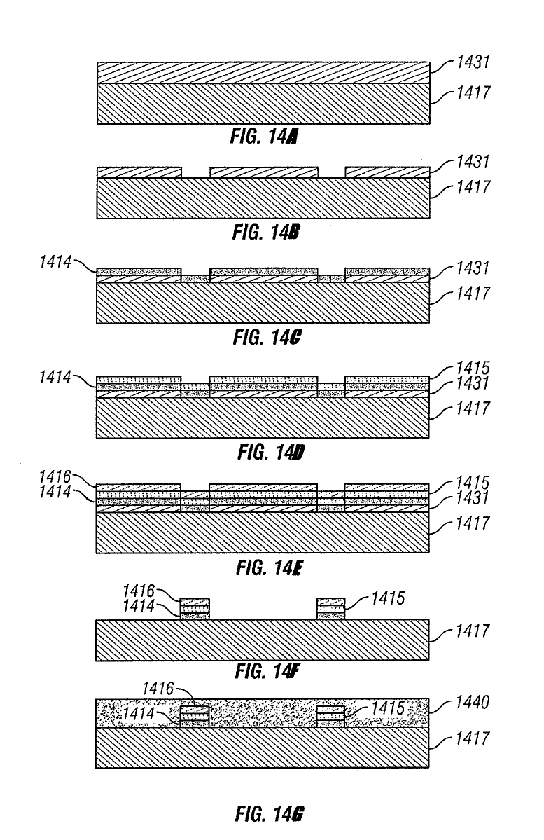

FIGS. 14A-14G illustrate an alternative fabrication process which may be used for fabricating a display having quantum dots, for example, the embodiment illustrated in FIG. 12B. The process begins, as shown in FIG. 14A, with a substrate 1417 upon which a photo resist layer 1431 is coated. Similarly to the process described above, and as shown in FIG. 14B, the photo resist layer 1431 may be patterned using lithography or any appropriate method to form a number of holes 1435. As shown in FIGS. 14C-14E, a quantum dot layer 1414, a reflective layer 1415, and an absorbing layer 1416 are then deposited on the display. FIG. 14F shows the device after using a photo resist liftoff technique which leaves exposed projections. FIG. 14G shows the device protected by the deposition of a protective dielectric layer 1440.

FIGS. 15A-15D illustrate another fabrication process which may be useful for fabricating a display having quantum dots, for example, the embodiment illustrated in FIG. 12B. The process begins, as shown in FIG. 15A, with a plastic 1521 in which holes have been embossed in a pattern indicating the fabrication sites of quantum dots. FIGS. 15B-15D show successive layers of material printed into the holes using, for example, an ink jet process. Each of the materials may be suitable for an absorbing layer 1516, a reflective layer 1515, and quantum dot layer 1514 material. The holes advantageously mitigate the spreading tendency of deposited materials by confining the material to the hole.

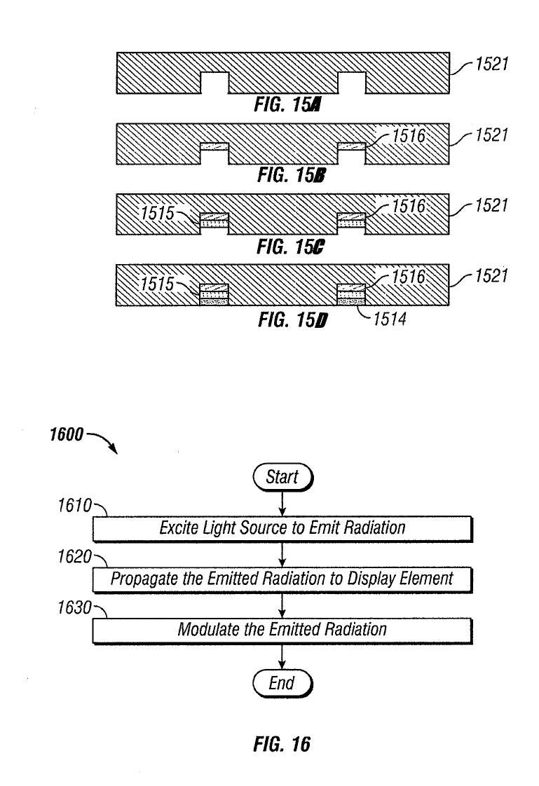

FIG. 16 is a flowchart illustrating a method of displaying an image. The process 1600 begins, in block 1610, with the excitation of a light source to emit radiation. In one embodiment, the light source is an array of quantum dots positioned above a reflective display. A light source comprising quantum dots can be excited by applying a voltage or current between electrodes of the light source or by exposing the quantum dots to short-wavelength light. In another embodiment, the light source is a multi-colored LED, which can also be excited by applying a voltage or current between electrodes of the light source. The radiation emitted may be narrowband radiation or broadband radiation. The radiation may be further altered, such as in the case when the light source is a phosphor-based LED and the emitted light is absorbed and reemitted at different wavelengths by quantum dots.

In block 1620, the emitted radiation is propagated to display elements. The emitted radiation may be propagated directly or indirectly. For example, the emitted radiation may be redirected through a light bar which uniformly directs radiation over an array of display elements. The display elements may include interferometric modulators, liquid crystal display elements, electrophoretic display elements, or other specular display elements. In block 1630, the emitted radiation is modulated by the display elements to display an image. The interferometric modulators can be controlled to modulate light from emitted from the quantum dots to display a desired image, for example, as described in the text corresponding to FIGS. 2-6B.

While the above description points out certain novel features of the invention as applied to various embodiments, the skilled person will understand that various omissions, substitutions, and changes in the form and details of the device or process illustrated may be made without departing from the scope of the invention. Therefore, the scope of the invention is defined by the appended claims rather than by the foregoing description. All variations coming within the meaning and range of equivalency of the claims are embraced within their scope.

1. A display comprising:
a plurality of interferometric modulators configured to reflect a spectrum of radiation having a reflectance response peak at one or more wavelengths, wherein the plurality of interferometric modulators comprises a plurality of first interferometric modulators each having a reflective layer movable relative to a partially reflective layer to form a resonant optical cavity therebetween, and wherein the resonant optical cavities of the first interferometric modulators are configured to reflect a spectrum of radiation having a reflectance response peak at a first wavelength; and
a plurality of quantum dots configured to emit radiation having a peak wavelength substantially at said one or more wavelengths, wherein the plurality of quantum dots includes a plurality of first quantum dots configured to emit radiation having a peak wavelength substantially matching said first wavelength, and
wherein the display is configured such that light emitted from said quantum dots irradiates said plurality of interferometric modulators.

2. The display of claim 1, further comprising a light source that provides radiation to pump said plurality of quantum dots to emit radiation at said one or more wavelengths.

3. The display of claim 1, wherein the plurality of interferometric modulators further comprises a plurality of second interferometric modulators each having a reflective layer movable relative to a partially reflective layer to form a resonant optical cavity therebetween, wherein the resonant optical cavities of the second interferometric modulators are configured to reflect a second spectrum of radiation having a reflectance response peak at a second wavelength, and wherein the plurality of quantum dots further comprises a plurality of second quantum dots configured to emit radiation having a peak wavelength substantially matching said second wavelength.

4. The display of claim 3, wherein said first and second wavelengths are different.

5. The display of claim 3, further comprising:
a plurality of third interferometric modulators each having a reflective layer movable relative to a partially reflective layer to form a resonant optical cavity therebetween, wherein the resonant optical cavities of the third interferometric modulators are configured to reflect a third spectrum of light having a reflectance response peak at a third wavelength; and
a plurality of third quantum dots configured to emit radiation having a peak wavelength substantially matching said third wavelength.

6. The display of claim 5, wherein the peak wavelength of the first quantum dots emitted radiation is within about 10 nm of the first wavelength, and wherein the peak wavelength of the second quantum dots emitted radiation is within about 10 nm of the second wavelength, and wherein the peak wavelength of the third quantum dots emitted radiation is within about 10 nm of the third wavelength.

7. The display of claim 5, wherein
radiation of said first wavelength is blue light;
radiation of said second wavelength is green light; and
radiation said third wavelength is red light.

8. The display of claim 3, wherein said first wavelength is between about 460 nm and about 490 nm.

9. The display of claim 3, wherein said second wavelength is between about 495 nm and about 525 nm.

10. The display of claim 5, wherein said third wavelength is between about 635 nm and about 665 nm.

11. The display of claim 3, wherein
the first wavelength is between about 470 nm and about 480 nm;
the second wavelength is between about 505 nm and about 515 nm; and
the third wavelength is between about 640 nm and about 660 nm.

12. The display of claim 3, further comprising a light source that provides radiation to pump said plurality of quantum dots to emit radiation at said one or more wavelengths.

13. The display of claim 5, further comprising a light source that provides radiation to pump said plurality of first, second and third quantum dots to emit radiation having a peak wavelength substantially at said respective first, second and third wavelengths.

14. The display of claim 1, wherein said plurality of quantum dots essentially comprise material selected from the group consisting of cadmium selenide (CdSe), Calcium sulfide (CdS), Indium arsenide (InAs), and Indium Phosphide (InP).

15. The display of claim 5, wherein
said plurality of first quantum dots range in size between about two (2) nanometers and about five (5) nanometers;
said plurality of second quantum dots range in size between about five (5) nanometers and about ten (10) nanometers; and
said plurality of third quantum dots range in size between about ten (10) nanometers and about fifty (50) nanometers.

16. The display of claim 1, further comprising:
a processor that is in electrical communication with the display, the processor being configured to process image data; and
a memory device in electrical communication with the processor.

17. The display of claim 16, further comprising:
a first controller configured to send at least one signal to the display; and
a second controller configured to send at least a portion of the image data to the first controller.

18. The display of claim 16, further comprising an image source module configured to send the image data to the processor.

19. The display of claim 18, wherein the image source module comprises at least one of a receiver, transceiver, and transmitter.

20. The display of claim 16, further comprising an input device configured to receive input data and to communicate the input data to the processor.

21. The display of claim 1, further comprising:
a light guide having an upper surface, a lower surface and one or more edge surfaces that are configured to receive light, the light guide positioned in front of the at least one interferometric modulator so that the lower surface of the light guide is disposed towards the at least one interferometric modulator; and
a light bar having a light emitting portion that is positioned along at least one of the edge surfaces of the light guide and provides light to said light guide,
wherein said plurality of quantum dots are disposed in said light emitting portion of the light bar.

22. The display of claim 1, further comprising:
a light guide having an upper surface, a lower surface and one or more edge surfaces that are configured to receive light, the light guide positioned in front of the at least one interferometric modulator so that the lower surface of the light guide is disposed towards the at least one interferometric modulator; and
a light bar having a light emitting portion and a light receiving portion, the light emitting portion disposed along an edge surface of the light guide,
wherein said plurality of quantum dots are disposed on said light receiving portion of the light bar.

23. The display of claim 1, further comprising:
a light guide having an upper surface, a lower surface and one or more edge surfaces that are configured to receive light from a light source, the light guide positioned in front of the at least one interferometric modulator so that the lower surface of the light guide is disposed towards the at least one interferometric modulator; and
wherein said quantum dots are disposed on at least one edge surface of said light guide which is configured to receive light.

24. The display of claim 1, further comprising:
a light guide having an upper surface, a lower surface and one or more edge surfaces that are configured to receive light, the light guide positioned in front of the at least one interferometric modulator so that the lower surface of the light guide is disposed towards the at least one interferometric modulator,
wherein said first quantum dots are disposed on the light guide at least partially below the at least one edge surface of the light guide.

25. The display of claim 1, further comprising:
a light guide having an upper surface, a lower surface and one or more edge surfaces that are configured to receive light, the light guide positioned in front of the at least one interferometric modulator so that the lower surface of the light guide is disposed towards the at least one interferometric modulator;
a light bar having a light emitting portion and a light receiving portion, the light emitting portion disposed along an edge surface of the light guide; and
a light source positioned to provide light to the light receiving portion of the light bar.

26. The display of claim 1, wherein said plurality of quantum dots are configured to emit radiation in response to electrical stimulation.

27. The display of claim 1, further comprising a light guide having an upper surface, a lower surface and one or more edge surfaces that are configured to receive light, the light guide positioned in front of the said first interferometric modulators so that the lower surface of the light guide is disposed towards said first interferometric modulators, wherein said plurality of quantum dots are disposed in the light guide.

28. The display of claim 27, wherein at least one of said plurality of quantum dots comprises:
an absorption layer; and
irradiating material disposed below said absorption layer, said irradiating material capable of emitting radiation having a peak wavelength substantially at said first wavelength.

29. A method of illumination, comprising:
illuminating quantum dots with radiation;
emitting radiation from the quantum dots, the emitted radiation having a first peak wavelength substantially matching a first wavelength; and
propagating the emitted radiation to first interferometric modulators each having a reflective layer movable relative to a partially reflective layer to form a resonant optical cavity therebetween, wherein the resonant optical cavities of the first interferometric modulators are configured to reflect a spectrum of radiation having a reflectance response peak substantially at the first wavelength.

30. The method of claim 29, wherein the emitted radiation further has a second peak wavelength substantially matching a second wavelength and a third peak wavelength substantially matching a third wavelength.

31. The method of claim 30, further comprising propagating the emitted radiation to second and third interferometric modulators configured to reflect a spectrum of radiation having a reflectance response peak substantially at the second and third wavelengths, respectively.

32. The method of claim 29, wherein propagating the emitted radiation to the interferometric modulators comprises reflecting the radiation with a light bar.

33. The method of claim 29, wherein propagating the emitted radiation to the interferometric modulators comprises reflecting the radiation with a parabolic mirror.

34. The method of claim 29, wherein propagating the emitted radiation to the interferometric modulators comprises collimating at least a portion of the emitted radiation.

35. The method of claim 29, wherein propagating the emitted radiation to the interferometric modulators comprises propagating the emitted radiation through at least one of glass, plastic, or air.

36. A display comprising:
means to interferometrically modulate light configured to reflect a first spectrum of radiation having a reflectance response peak at a first wavelength; and
means to emit radiation having a peak wavelength substantially at said first wavelength, the display being configured such that said radiation emitting means irradiate said light modulating means.

37. The display of claim 36, wherein the means to interferometrically modulate light comprises a plurality of interferometric modulators.

38. The display of claim 36, wherein the means to emit radiation comprises a plurality of quantum dots.
